(19) United States
(12) Patent Application Publication
(10) Pub. No.: US 2026/0194911 A1
(43) Pub. Date: Jul. 9, 2026

(54) AUTONOMOUS MOBILE ROBOT AND METHOD FOR AUTONOMOUS MOBILE ROBOT TO ESCAPE FROM ROUGH TERRAIN

(71) Applicant: SAMSUNG ELECTRONICS CO., LTD., Suwon-si (KR)

(72) Inventors: Dooyoung YANG, Suwon-si (KR); Wondong LEE, Suwon-si (KR)

(73) Assignee: SAMSUNG ELECTRONICS CO., LTD., Suwon-si (KR)

(21) Appl. No.: 19/548,483

(22) Filed: Feb. 24, 2026

Related U.S. Application Data
(63) Continuation of application No. PCT/KR2026/000364, filed on Jan. 7, 2026.

(30) Foreign Application Priority Data
Jan. 7, 2025 (KR) 10-2025-0002006

(51) Int. Cl. G05D 1/639; G05D 107/60; G05D 109/10; G05D 111/10; G05D 111/50

(52) U.S. Cl. CPC G05D 1/639; G05D 2107/60; G05D 2109/10; G05D 2111/17; G05D 2111/52

(57) ABSTRACT

An autonomous mobile robot includes a body, drive wheels on the body, motors respectively configured to drive the drive wheels, a suspension on a lower portion of the body and configured to support the motors such that the motors move vertically relative to the body, a sensor on the body and configured to detect surroundings, and a processor configured to control the motors, where the processor is configured to determine that at least one drive wheel of the drive wheels is stuck on a rough terrain based on identifying, using the sensor, that the body is not moving or is moving along a different path from an expected path, and based on determining that the at least one drive wheel is stuck on the rough terrain, vibrate at least one motor of the motors that corresponds to the at least one drive wheel and rotate the at least one motor in a first direction.

### CROSS-REFERENCE TO RELATED APPLICATION(S)

This application is a continuation application of International application No. PCT/KR 2026/000364, filed on Jan. 7, 2026, in the Korean Intellectual Property Receiving Office, which is based on and claims priority to Korean Patent Application No. 10-2025-0002006, filed on Jan. 7, 2025, in the Korean Intellectual Property Office, the disclosures of which are incorporated by reference herein in their entireties.

### BACKGROUND

### 1. Field

The disclosure relates to an autonomous mobile robot, and more particularly, to an autonomous mobile robot capable of escaping from a rough terrain and a method for an autonomous mobile robot to escape from a rough terrain.

### 2. Description of Related Art

With the advancement of robotics technology, autonomous mobile robots are becoming widely used.

When a user sets a destination, an autonomous mobile robot may explore its surroundings in real time and autonomously select an optimal path to reach the destination without the user providing direct instructions regarding a moving path or specifying the moving path in advance.

Therefore, the autonomous mobile robots are required to be able to move on surfaces of various shapes.

For example, the autonomous mobile robots are required to be able to pass through a rough terrain, such as drain grates disposed to cover drains in roads or restaurant kitchens.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments.

According to an aspect of an example embodiment, an autonomous mobile robot may include a body, drive wheels on the body, motors respectively configured to drive the drive wheels, a suspension on a lower portion of the body and configured to support the motors such that the motors move vertically relative to the body, a sensor on the body and configured to detect surroundings, and a processor configured to control the motors, where the processor is configured to determine that at least one drive wheel of the drive wheels is stuck on a rough terrain based on identifying, using the sensor, that the body is not moving or is moving along a different path from an expected path, and based on determining that the at least one drive wheel is stuck on the rough terrain, vibrate at least one motor of the motors that corresponds to the at least one drive wheel and rotate the at least one motor in a first direction.

The autonomous mobile robot may include a motor driver configured to control the motors, and the processor may be further configured to adjust a gain of the motor driver such that the at least one motor vibrates.

The motor driver may be configured to transmit a composite signal to the at least one motor, the composite signal including a motor rotation signal that causes the at least one motor to rotate and a motor vibration signal that causes the at least one motor to vibrate.

The motors may include a left motor and a right motor, and the suspension may include a left hinge axle and a right hinge axle at the lower portion of the body, a left bogie link rotatably provided on the left hinge axle and including the left motor at a first end thereof, a left front support wheel at a second end of the left bogie link, a right bogie link rotatably provided on the right hinge axle and including the right motor at a first end thereof, and a right front support wheel at a second end of the right bogie link.

The motors may be respectively at a center of the drive wheels.

The drive wheels may include a first drive wheel and a second drive wheel, the motors may include a first motor configured to drive the first drive wheel and a second motor configured to drive the second drive wheel, and the at least one wheel is the first drive wheel and the at least one motor is the first motor.

The processor may be further configured to, based on determining that the first drive wheel is stuck on the rough terrain and that the second drive wheel is not stuck on the rough terrain, vibrate the first motor and rotate the first motor in the first direction and rotate the second motor in the first direction without vibrating the second motor.

The autonomous mobile robot may include a motor driver configured to control the first motor and the second motor, and the processor may be further configured to adjust a gain of the motor driver such that the first motor vibrates and rotates the first motor in the first direction and the second motor rotates in the first direction without vibrating.

The processor may be configured to determine that the at least one drive wheel is stuck on the rough terrain based on a curvature of a current path of the autonomous mobile robot being different from a curvature of the expected path.

The processor may be configured to determine that the at least one drive wheel is stuck on the rough terrain based on a current rotation speed of the at least one drive wheel not matching a target rotation speed of the at least one drive wheel.

According to an aspect of an example embodiment, a method for an autonomous mobile robot, the autonomous mobile robot including a body, drive wheels on the body, motors respectively configured to drive the drive wheels, and a sensor on the body, may include rotating the motors in a first direction at an equal speed, identifying, using the sensor, whether a position of the body changes, determining that the drive wheels are stuck on a rough terrain based on the position of the body not being changed, and based on determining that the drive wheels are stuck on the rough terrain, rotating the drive wheels in the first direction while vibrating the drive wheels vertically relative to the body.

The autonomous mobile robot may include a motor driver configured to control the motors, and the method may include adjusting a gain of the motor driver such that the motors vibrate and rotate in the first direction.

The method may include transmitting, by the motor driver, a composite signal to the motors and the composite signal may include a motor rotation signal that causes the motors to rotate in the first direction and a motor vibration signal that causes the motors to vibrate.

A frequency of the motor rotation signal may be 0.1 Hz, and a frequency of the motor vibration signal may be 50 Hz.

The motor driver may include a proportional-integration-differential controller.

The autonomous mobile robot may include a suspension configured to support the drive wheels.

According to an aspect of an example embodiment, a method for an autonomous mobile robot, the autonomous mobile robot including a body, a first drive wheel and a second drive wheel on the body, a first motor configured to drive the first drive wheel, a second motor configured to drive the second drive wheel, and a sensor on the body, may include rotating the first motor and the second motor in a first direction and at different speeds, identifying, using the sensor, whether a movement path of the body matches an expected path, determining, based on the movement path of the body being different from the expected path, that the first drive wheel is stuck on a rough terrain and based on determining that the first drive wheel is stuck on the rough terrain, and by the first motor, rotating the first drive wheel stuck on the rough terrain in the first direction while vibrating vertically relative to the body.

The autonomous mobile robot may include a motor driver configured to control the first motor and the second motor, the second drive wheel is not stuck on the rough terrain, and the method may include adjusting a gain of the motor driver such that the first motor rotates in the first direction while vibrating, and the second motor to rotate in the first direction without vibrating.

The method may include transmitting, by the motor driver, a composite signal to the first motor, and the composite signal may include a motor rotation signal that causes the first motor to rotate in the first direction and a motor vibration signal that causes the first motor to vibrate.

The motor driver may include a proportional-integration-differential controller.

### BRIEF DESCRIPTION OF DRAWINGS

The above and other aspects, features, and advantages of certain example embodiments of the present disclosure will be more apparent from the following description taken in conjunction with the accompanying drawings.

FIG. 1 is a perspective view illustrating an autonomous mobile robot according to one or more embodiments of the disclosure.

FIG. 2 is a side view illustrating a pair of drive wheels and a suspension of an autonomous mobile robot according to one or more embodiments of the disclosure.

FIG. 3 is a bottom view illustrating a pair of drive wheels and a suspension of an autonomous mobile robot according to one or more embodiments of the disclosure.

FIG. 4 is a view illustrating a suspension used in an autonomous mobile robot according to one or more embodiments of the disclosure.

FIG. 5A is a side view illustrating a state in which a drive wheel of an autonomous mobile robot is stuck on a rough terrain according to one or more embodiments of the disclosure.

FIG. 5B is a plan view illustrating a state in which the drive wheel of the autonomous mobile robot of FIG. 5A is stuck on the rough terrain according to one or more embodiments of the disclosure.

FIG. 6A is a side view illustrating a state in which a drive wheel of an autonomous mobile robot is stuck on a rough terrain according to one or more embodiments of the disclosure.

FIG. 6B is a plan view illustrating a state in which the drive wheel of the autonomous mobile robot of FIG. 6A is stuck on the rough terrain according to one or more embodiments of the disclosure.

FIG. 7 is a block diagram illustrating an autonomous mobile robot according to one or more embodiments of the disclosure.

FIG. 8 is a diagram illustrating the relationship between an autonomous driving algorithm and a motor control algorithm of an autonomous mobile robot according to one or more embodiments of the disclosure.

FIG. 9 is a flowchart illustrating a method for an autonomous mobile robot to escape from a rough terrain according to one or more embodiments of the disclosure.

FIG. 10 is a conceptual diagram illustrating a state in which an autonomous mobile robot is moving straight according to one or more embodiments of the disclosure.

FIG. 11 is a conceptual diagram illustrating a state in which a pair of drive wheels of an autonomous mobile robot, moving straight, have stuck on a rough terrain according to one or more embodiments of the disclosure.

FIG. 12 is a conceptual diagram illustrating a state in which a left drive wheel of an autonomous mobile robot, moving straight, has stuck on a rough terrain according to one or more embodiments of the disclosure.

FIG. 13 is a conceptual diagram illustrating a state in which a right drive wheel of an autonomous mobile robot, moving straight, has stuck on a rough terrain according to one or more embodiments of the disclosure.

FIG. 14 is a conceptual diagram illustrating a state in which an autonomous mobile robot is turning right according to one or more embodiments of the disclosure.

FIG. 15 is a conceptual diagram illustrating a state in which a left drive wheel of an autonomous mobile robot, turning right, has stuck on a rough terrain according to one or more embodiments of the disclosure.

FIG. 16 is a conceptual diagram illustrating a state in which a right drive wheel of an autonomous mobile robot, turning right, has stuck on a rough terrain according to one or more embodiments of the disclosure.

FIG. 17 is a conceptual diagram illustrating a state in which an autonomous mobile robot is turning left according to one or more embodiments of the disclosure.

FIG. 18 is a conceptual diagram illustrating a state in which a right drive wheel of an autonomous mobile robot, turning left, has stuck on a rough terrain according to one or more embodiments of the disclosure.

FIG. 19 is a conceptual diagram illustrating a state in which a left drive wheel of an autonomous mobile robot, turning left, has stuck on a rough terrain according to one or more embodiments of the disclosure.

FIG. 20 is a control block diagram of a pair of motors of an autonomous mobile robot according to one or more embodiments of the disclosure.

FIG. 21 a control block diagram of a motor when a speed controller is implemented as a proportional-integration-differential (PID) controller.

FIG. 22 is a Bode plot illustrating a speed controller of a motor driver of an autonomous mobile robot according to one or more embodiments of the disclosure.

FIG. 23 is a graph illustrating changes in the magnitude and phase of the 10 Hz signal in the Bode plot of FIG. 22 over time.

FIG. 24 is a graph illustrating the graph of FIG. 23 with an error value added.

FIG. 25 is a Bode plot illustrating a speed controller of a motor driver of an autonomous mobile robot according to one or more embodiments of the disclosure.

FIG. 26 is a graph illustrating changes in the magnitude and phase of the 50 Hz signal in the Bode plot of FIG. 25 and the error value over time.

FIG. 27 is a graph illustrating a composite signal input to a PID controller of a motor driver.

FIG. 28 is a graph illustrating the composite signal of FIG. 27 as separate signals.

FIG. 29 is a conceptual diagram illustrating rotation and vibration of a drive wheel due to a composite signal input to a motor driver.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

Terms such as first, second, etc. may be used to describe various components, but are used only for the purpose of distinguishing one component from another component. These terms do not limit the difference in the material or structure of the components.

The terms of a singular form may include plural forms unless otherwise specified. In addition, when a certain part “includes” a certain component, it means that other components may be further included rather than excluding other components unless otherwise stated.

In addition, terms such as “unit” and “module” described in the specification may indicate a unit that processes at least one function or operation, and this may be implemented as hardware or software, or may be implemented as a combination of hardware and software.

The use of the term “the” and similar designating terms may correspond to both the singular and the plural.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

Further, the terms ‘leading end’, ‘rear end’, ‘upper side’, ‘lower side’, ‘top end’, ‘bottom end’, etc. used in the disclosure are defined with reference to the drawings. However, the shape and position of each component are not limited by the terms.

The disclosure provides an autonomous mobile robot capable of escaping form a rough terrain and a method for an autonomous mobile robot to escape from rough terrain.

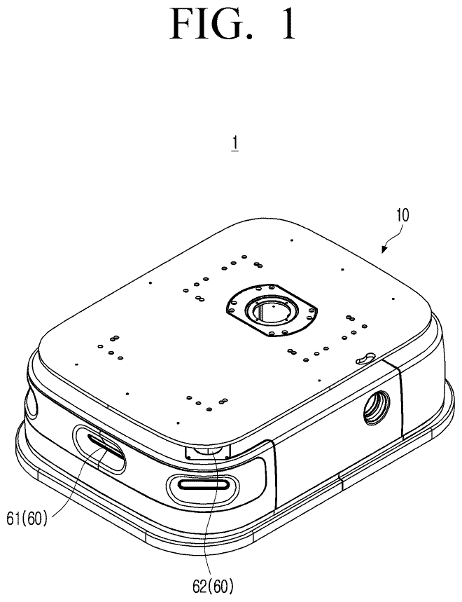

Hereinafter, an autonomous mobile robot 1 according to one or more embodiments of the disclosure will be described with reference to FIGS. 1, 2, and 3.

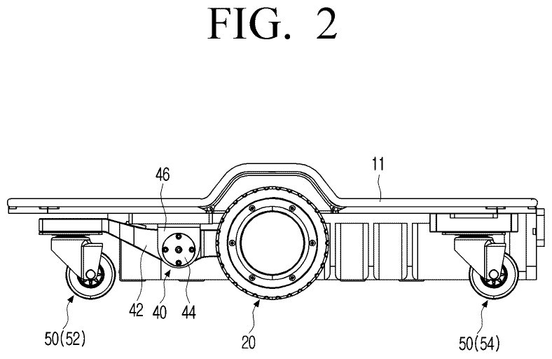

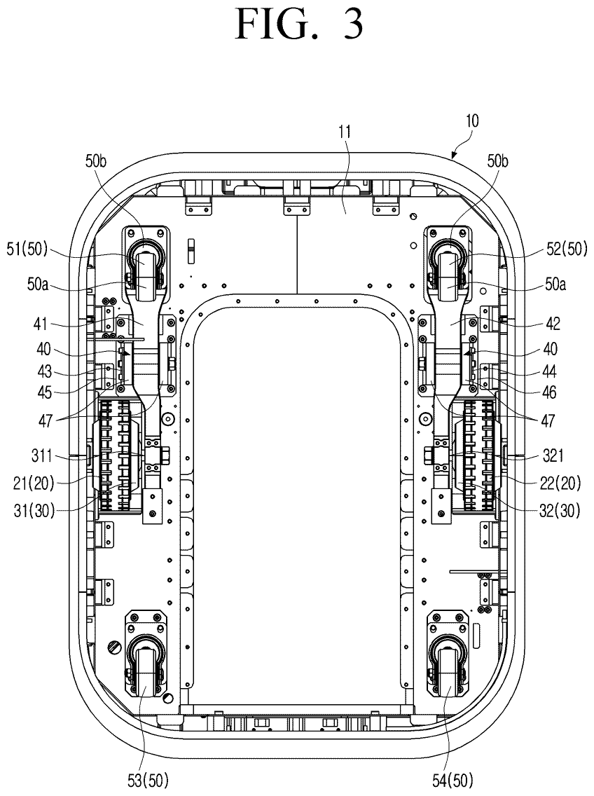

FIG. 1 is a perspective view illustrating an autonomous mobile robot 1 according to one or more embodiments of the disclosure. FIG. 2 is a side view illustrating a pair of drive wheels 20 and a suspension 40 of an autonomous mobile robot 1 according to one or more embodiments of the disclosure. FIG. 3 is a bottom view illustrating a pair of drive wheels 20 and a suspension 40 of an autonomous mobile robot 1 according to one or more embodiments of the disclosure.

Referring to FIGS. 1, 2, and 3, an autonomous mobile robot 1 according to one or more embodiments of the disclosure may include a body 10, a pair of drive wheels 20, a pair of motors 30, a suspension 40, and a plurality of support wheels 50. As used herein, phraseology such as “at least one of the pair of . . . ” may refer to one item within the pair, such as one wheel of a pair of wheels.

The body 10 may form the exterior of the autonomous mobile robot 1. A processor 90, a sensor 60, and a power supply may be provided within the body 10 to control the autonomous mobile robot 1 to autonomously drive. A base 11 may be provided on the lower surface of the body 10.

According to one embodiment, the processor 90 may control the pair of motors 30 to move the body 10. The processor 90 may perform autonomous driving using the sensor 60 and the pair of motors 30 to move the body 10 to a target point.

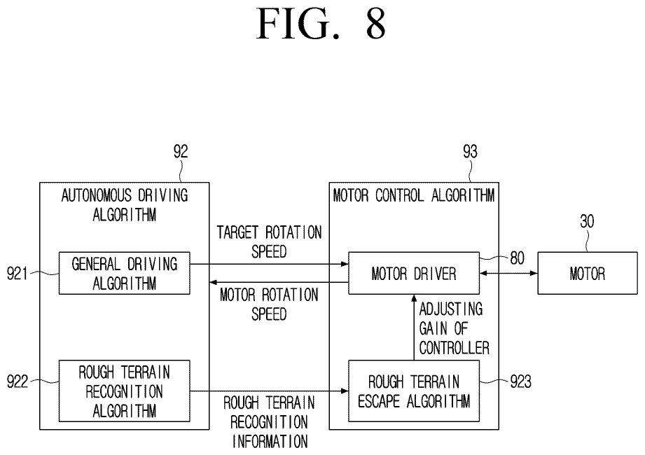

According to one embodiment, the processor 90 may be configured to detect that one of the pair of drive wheels 20 is stuck on a rough terrain. For example, the processor 90 may include a rough terrain recognition algorithm (922 of FIG. 8) configured to recognize that at least one of the pair of drive wheels 20 is stuck on the rough terrain.

For example, the rough terrain recognition algorithm 922 may recognize that at least one of the pair of drive wheels 20 is stuck on the rough terrain when the sensor 60 detects that the body 10 is not moving or that a movement path of body 10 differs from an expected path. Here, the rough terrain may refer to a place where frictional force is not applied to the drive wheel 20, preventing the drive wheel 20 from moving normally and causing the drive wheel 20 to rotate in place. For example, the rough terrain may refer to a slippery place, a place with small bumps, a place with grooves, etc.

According to one embodiment, the processor 90 may include a rough terrain escape algorithm (923 of FIG. 8) that controls at least one motor 30, which drives at least one drive wheel stuck on the rough terrain, among the pair of motors 30, thereby causing the at least one drive wheel to vibrate and rotate in one direction. For example, when the at least one of the pair of drive wheels 20 is stuck on the rough terrain, the processor 90 may activate the rough terrain escape algorithm 923.

According to one embodiment, the sensor 60 may include a plurality of camera sensors 61, a light detection and ranging (LIDAR) sensor 62, and an inertial measurement unit (IMU) sensor.

For example, the plurality of camera sensors 61 may be disposed on the front side of the body 10. The plurality of camera sensors 61 may be configured to capture images of the front of the autonomous mobile robot 1.

For example, the LIDAR sensor 62 may be disposed on the upper portion of the front side of the body 10. The LIDAR sensor 62 may be configured to measure the distance to obstacles located in front of the autonomous mobile robot 1.

For example, the IMU sensor may be disposed inside the body 10. The IMU sensor may be configured to measure the position, speed, and direction of the body 10, i.e., the autonomous mobile robot 1.

According to one embodiment, the processor 90 may recognize the current position of the body 10, i.e., the autonomous mobile robot 1, using the sensor 60, for example, at least one of the plurality of camera sensors 61, the LIDAR sensor 62, and the IMU sensor. In other words, the processor 90 may perform localization of the autonomous mobile robot 1 using the plurality of camera sensors 61, the LIDAR sensor 62, and the IMU sensor.

The power supply may be configured to supply power to various components disposed in the body 10. For example, the power supply may be configured to supply power to the processor 90, the plurality of camera sensors 61, the LIDAR sensor 62, the IMU sensor, and the pair of motors 30. For example, a rechargeable battery may be used as the power supply.

For example, the pair of drive wheels 20 may be configured to move the autonomous mobile robot 1. The pair of drive wheels 20 may be disposed on the base 11 of the body 10. The pair of drive wheels 20 may be disposed on the lower surface of the base 11 with the suspension 40.

The pair of drive wheels 20 may be configured to rotate by being driven by the pair of motors 30. In other words, the drive wheel 20 may be configured to rotate by being driven by the motor 30. For example, the motor 30 may be an in-wheel motor disposed at the center of the drive wheel 20. For example, each of the pair of drive wheels 20 may include the in-wheel motor.

When the motor 30 rotates, the drive wheel 20 may rotate. Here, the rotation of the motor 30 may refer to the rotation of a rotor. For example, the motor 30 may include a stator and the rotor. The stator is fixed, and the rotor may be disposed around the stator to rotate about the stator. In other words, the rotor may be configured as an outer rotor. For example, the stator of the motor 30 may be fixed to the suspension 40. The rotor may be coupled to the center of the drive wheel 20. Therefore, when the motor 30 operates, the drive wheel 20 may rotate integrally with the rotor.

For example, the pair of drive wheels 20 may include a left drive wheel 21 and a right drive wheel 22. The pair of motors 30 may include a left motor 31 and a right motor 32. The left motor 31 may be disposed at the center of the left drive wheel 21. The right motor 32 may be disposed at the center of the right drive wheel 22. Therefore, when the left motor 31 rotates, the left drive wheel 21 may rotate. When the right motor 32 rotates, the right drive wheel 22 may rotate.

The suspension 40 may be configured to couple the pair of motors 30 to the body 10. The suspension 40 may be configured to support the pair of motors 30 so that the pair of motors 30 may move up and down. Therefore, the pair of motors 30 may move up and down (i.e., vertically) with respect to the body 10 by way of the suspension 40. Because the pair of motors 30 are disposed at the centers of the pair of drive wheels 20, the pair of drive wheels 20 may move up and down with respect to the body 10 by way of the suspension 40.

The plurality of support wheels 50 may be disposed to support the body 10. The plurality of support wheels 50 may be configured to share the load of the body 10 along with the pair of drive wheels 20. The plurality of support wheels 50 may be configured so as not to generate a driving force to move the autonomous mobile robot 1. For example, casters may be used as the plurality of support wheels 50. However, the plurality of support wheels 50 may not be limited thereto. The plurality of support wheels 50 may be configured as various types of wheels.

For example, the plurality of support wheels 50 may be disposed at the front and rear portions of the lower portion of the body 10. The plurality of support wheels 50 may include a pair of front support wheels 51 and 52 and a pair of rear support wheels 53 and 54. The pair of front support wheels 51 and 52 may be positioned in front of the pair of drive wheels 20, and the pair of rear support wheels 53 and 54 may be positioned in the rear of the pair of drive wheels 20.

The pair of front support wheels 51 and 52 may include a left front support wheel 51 and a right front support wheel 52. The pair of rear support wheels 53 and 54 may include a left rear support wheel 53 and a right rear support wheel 54.

According to one embodiment, the suspension 40 may include a pair of bogie links 41 and 42 that support the pair of motors 30. The pair of bogie links 41 and 42 may be disposed to rotate about a pair of hinge axles 43 and 44 provided on the lower surface of the body 10.

The pair of bogie links 41 and 42 may be formed in the same shape. The bogie links 41 and 42 may be formed in a substantially rod-like shape. The bogie links 41 and 42 may be disposed to rotate about the hinge axles 43 and 44, respectively. The bogie links 41 and 42 may include hinge holes into which the hinge axles 43 and 44 are inserted, respectively.

The pair of hinge axles 43 and 44 may be supported by a pair of hinge brackets 45 and 46. The pair of hinge brackets 45 and 46 may be formed identically. Each of the hinge brackets 45 and 46 may include a pair of support plates 47 facing each other in parallel. Both ends of the hinge axle 43 or 44 may be supported by the pair of support plates 47. The hinge axles 43 and 44 may be inserted into the hinge holes of the bogie links 41 and 42, respectively. Bearings may be provided between the hinge holes of the bogie links 41 and 42 and the hinge axles 43 and 44, respectively. Therefore, the bogie links 41 and 42 may smoothly move up and down about the hinge axles 43 and 44, respectively.

For example, the pair of bogie links 41 and 42 may include a left bogie link 41 and a right bogie link 42. The pair of hinge axles 43 and 44 may include a left hinge axle 43 and a right hinge axle 44.

The left bogie link 41 may rotate about the left hinge axle 43. In other words, the left bogie link 41 may seesaw about the left hinge axle 43.

The left drive wheel 21 may be disposed at one end of the left bogie link 41. For example, a fixed shaft 311 of the left motor 31 may be fixed to one end of the left bogie link 41. Accordingly, the left motor 31 may be fixed to one end of the left bogie link 41, and the left drive wheel 21 may rotate with respect to one end of the left bogie link 41. The left front support wheel 51 may be disposed at the other end of the left bogie link 41. For example, a caster bracket 50b that rotatably supports a caster wheel 50a of the left front support wheel 51 may be fixed to the other end of the left bogie link 41. Therefore, the left front support wheel 51 may rotate with respect to the other end of the left bogie link 41.

Accordingly, the left drive wheel 21 and the left motor 31 may move up and down about the left hinge axle 43. The left drive wheel 21 and the left front support wheel 51 may simultaneously contact a driving surface on which the autonomous mobile robot 1 moves. Alternatively, depending on the shape of the driving surface, only one of the left drive wheel 21 and the left front support wheel 51 may contact the driving surface.

The right bogie link 42 may rotate about the right hinge axle 44. In other words, the right bogie link 42 may seesaw about the right hinge axle 44.

The right drive wheel 22 may be disposed at one end of the right bogie link 42. For example, a fixed shaft 321 of the right motor 32 may be fixed to one end of the right bogie link 42. Accordingly, the right motor 32 may be fixed to one end of the right bogie link 42, and the right drive wheel 22 may rotate with respect to one end of the right bogie link 42. The right front support wheel 52 may be disposed at the other end of the right bogie link 42. For example, a caster bracket 50b that rotatably supports a caster wheel 50a of the right front support wheel 52 may be fixed to the other end of the right bogie link 42. Therefore, the right front support wheel 52 may rotate with respect to the other end of the right bogie link 42.

Accordingly, the right drive wheel 22 and the right motor 32 may move up and down about the right hinge axle 44. The right drive wheel 22 and the right front support wheel 52 may simultaneously contact the driving surface on which the autonomous mobile robot 1 moves. Alternatively, depending on the shape of the driving surface, only one of the right drive wheel 22 and the right front support wheel 52 may contact the driving surface.

The pair of rear support wheels 53 and 54 may be disposed on the lower surface of the base 11 of the body 10. The pair of rear support wheels 53 and 54 may be formed as casters, similar to the pair of front support wheels 51 and 52. The pair of rear support wheels 53 and 54 may be disposed so as not to move up and down relative to the base 11 of the body 10.

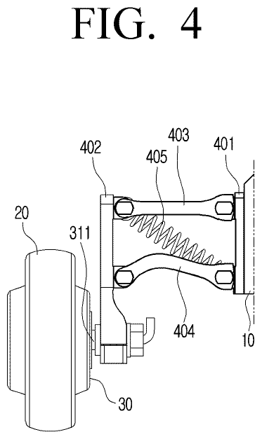

While the suspension 40 is formed as the bogie links 41 and 42 in FIGS. 2 and 3, the suspension 40 used in the autonomous mobile robot 1 according to one or more embodiments of the disclosure may not be limited thereto. As illustrated in FIG. 4, the suspension 40 may be configured similarly to a double wishbone suspension.

FIG. 4 is a view illustrating a suspension 40 used in an autonomous mobile robot 1 according to one or more embodiments of the disclosure.

Referring to FIG. 4, the suspension 40 according to one or more embodiments of the disclosure may include a fixed plate 401, a moving plate 402, an upper link 403, a lower link 404, and a coil spring 405.

The fixed plate 401 may be disposed on the body 10. For example, the fixed plate 401 may be fixed to one side of the lower portion of the body 10. The fixed plate 401 may be formed as a rectangular flat plate.

The moving plate 402 may be spaced a certain distance from the fixed plate 401 and disposed parallel to the fixed plate 401. The moving plate 402 may be formed as a rectangular flat plate. The drive wheel 20 may be disposed on the moving plate 402. The drive wheel 20 may be disposed on the lower portion of the moving plate 402. The fixed shaft 311 of the in-wheel motor 30 of the drive wheel 20 may be fixed to the moving plate 402.

The upper link 403 and the lower link 404 may be disposed between the fixed plate 401 and the moving plate 402.

One end of the upper link 403 may be rotatably disposed on the fixed plate 401, and the other end thereof may be rotatably disposed on the moving plate 402. The upper link 403 may be formed in the shape of a straight bar.

The lower link 404 may be disposed below the upper link 403. One end of the lower link 404 may be rotatably disposed on the fixed plate 401, and the other end thereof may be rotatably disposed on the moving plate 402. The lower link 404 may be formed in the shape of a curved bar protruding upward.

The coil spring 405 may be configured to apply a force in a downward direction to the drive wheel 20. When the coil spring 405 applies a force in a downward direction to the drive wheel 20, the drive wheel 20 may maintain contact with the driving surface. Therefore, when there is an unevenness on the driving surface, the drive wheels 20 may move while maintaining contact with the driving surface.

The coil spring 405 may be diagonally disposed between the fixed plate 401 and the moving plate 402. The coil spring 405 may be diagonally disposed between the upper link 403 and the lower link 404. For example, one end of the coil spring 405 may be connected to one end of the upper link 403 disposed on the moving plate 402, and the other end of the coil spring 405 may be connected to the other end of the lower link 404 disposed on the fixed plate 401. In this case, the coil spring 405 may be a tension spring.

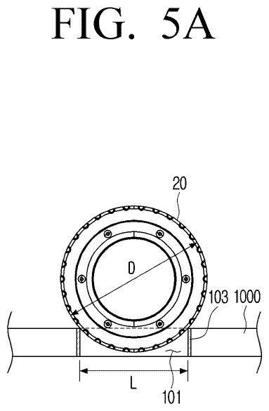

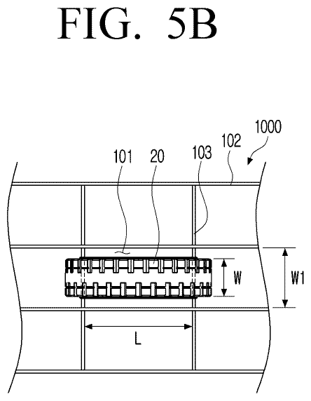

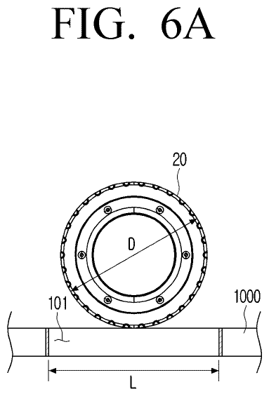

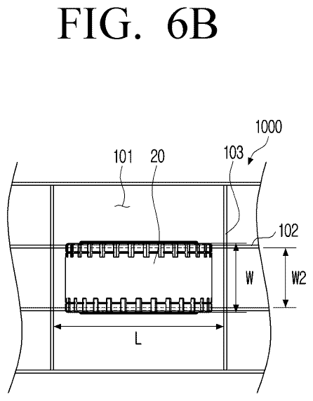

Hereinafter, with reference to FIGS. 5A, 5B, 6A, and 6B, a case in which the autonomous mobile robot 1 is stuck on a rough terrain according to one or more embodiments of the disclosure will be described. Here, a drain grate 1000 used in a kitchen of a restaurant is exemplified as an example of the rough terrain.

FIG. 5A is a side view illustrating a state in which a drive wheel 20 of an autonomous mobile robot 1 is stuck on a rough terrain according to one or more embodiments of the disclosure. FIG. 5B is a plan view illustrating a state in which the drive wheel 20 of the autonomous mobile robot 1 of FIG. 5A is stuck on the rough terrain according to one or more embodiments of the disclosure.

Referring to FIGS. 5A and 5B, the drain grate 1000 may include a plurality of rectangular holes 101. The drive wheel 20 may be positioned above the rectangular holes 101 of the drain grate 1000. A portion of the drive wheel 20 may be positioned inside the rectangular hole 101. The width W of the drive wheel 20 may be narrower than the width W1 of the rectangular hole 101. However, because the diameter D of the drive wheel 20 is larger than the length L of the rectangular hole 101, the drive wheel 20 may get caught on a vertical bulkhead 103, and thus the drive wheel 20 may not completely fall into the rectangular hole 101 of the drain grate 1000.

In this way, in the case that only a portion of the drive wheel 20 comes into contact with the drain grate 1000, when the drive wheel 20 rotates, sufficient frictional force may not be applied to the drive wheel 20, so the drive wheel 20 may not move forward and may rotate in place. In other words, the drive wheel 20 may be stuck on the rough terrain.

FIG. 6A is a side view illustrating a state in which a drive wheel 20 of an autonomous mobile robot 1 is stuck on a rough terrain according to one or more embodiments of the disclosure. FIG. 6B is a plan view illustrating a state in which the drive wheel 20 of the autonomous mobile robot 1 of FIG. 6A is stuck on the rough terrain according to one or more embodiments of the disclosure.

Referring to FIGS. 6A and 6B, the drive wheel 20 may be positioned above the rectangular hole 101 of the drain grate 1000. A portion of the drive wheel 20 may be positioned inside the rectangular hole 101. The diameter D of the drive wheel 20 may be smaller than the length L of the rectangular hole 101. However, because the width W of the drive wheel 20 is wider than the width W2 of the rectangular hole 101, the drive wheel 20 may get caught on a horizontal bulkhead 102, and thus the drive wheel 20 may not completely fall into the rectangular hole 101 of the drain grate 1000.

In this way, in the case that only a portion of the drive wheel 20 comes into contact with the drain grate 1000, when the drive wheel 20 rotates, sufficient frictional force may not be applied to the drive wheel 20, so the drive wheel 20 may not move forward and may rotate in place. In other words, the drive wheel 20 may be stuck on the rough terrain.

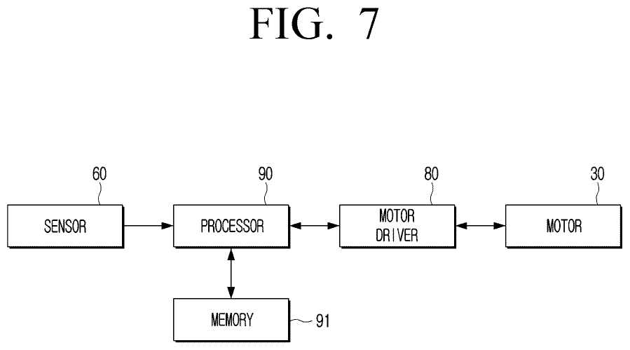

Hereinafter, a method for an autonomous mobile robot 1 to autonomously drive according to one or more embodiments of the disclosure will be described with reference to FIGS. 7 and 8.

FIG. 7 is a block diagram illustrating an autonomous mobile robot 1 according to one or more embodiments of the disclosure.

Referring to FIG. 7, an autonomous mobile robot 1 according to one or more embodiments of the disclosure may include a motor 30 and a motor driver 80.

The motor 30 may be configured to rotate a drive wheel 20. The drive wheel 20 may rotate in both directions by the motor 30.

For example, the motor 30 may be configured as an in-wheel motor disposed at the center of the drive wheel 20. The motor 30 may include a stator and a rotor. The stator may be fixed to a suspension 40, and the rotor may be disposed around the stator to rotate about the stator. The rotor may be coupled to the center of the drive wheel 20. Therefore, when the motor 30 operates, the drive wheel 20 may rotate integrally with the rotor.

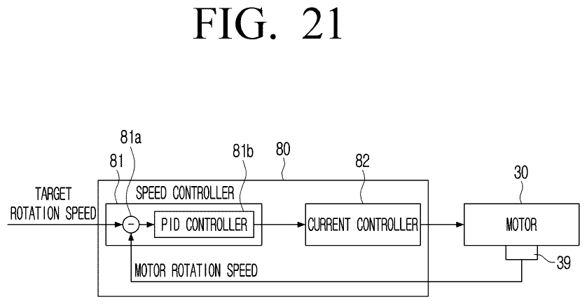

The motor driver 80 may be configured to control the forward and reverse rotation of the motor 30 and the speed of the motor 30. For example, the motor driver 80 may include a speed controller 81 (operation See FIG. 21) and a current controller 82 (operation See FIG. 21). The speed controller 81 may be configured to control the speed of the motor 30. The current controller 82 may be configured to control the torque of the motor 30.

The speed controller 81 may be configured to perform proportional-integration-differential (PID) control, proportional-integration (PI) control, and proportional-differential (PD) control. The speed controller 81 may be configured to adjust a gain. The gain of the speed controller 81 may include a proportional control gain, an integral control gain, and a differential control gain.

According to one embodiment, the autonomous mobile robot 1 according to one or more embodiments of the disclosure may include a sensor 60. For example, the autonomous mobile robot 1 may include a plurality of camera sensors 61, a LIDAR sensor 62, and an IMU sensor.

The plurality of camera sensors 61 may be configured to capture images of the front of the autonomous mobile robot 1. The LIDAR sensor 62 may be configured to measure the distance to an obstacle located in front of the autonomous mobile robot 1. The IMU sensor may be configured to measure the position, speed, and direction of the autonomous mobile robot 1.

According to one embodiment, the autonomous mobile robot 1 according to one or more embodiments of the disclosure may include a processor 90 and a memory 91.

The processor 90 may be configured to control the autonomous mobile robot 1 so that the autonomous mobile robot 1 may autonomously drive.

According to one embodiment, the processor 90 may recognize the current position of the autonomous mobile robot 1 using the sensor 60, for example, at least one of the plurality of camera sensors 61, the LIDAR sensor 62, and the IMU sensor. In other words, the processor 90 may perform localization of the autonomous mobile robot 1 using at least one of the plurality of camera sensors 61, the LIDAR sensor 62, and the IMU sensor.

For example, the processor 90 may be configured to control the motors 30 using information input from the sensor 60. By controlling the sensor 60 and the motors 30, the processor 90 may enable the autonomous mobile robot 1 to perform autonomous driving.

For example, the processor 90 may be configured to detect that the drive wheels 20 are stuck on a rough terrain. When the processor 90 detects that the drive wheels 20 are stuck on the rough terrain, the processor 90 may execute a rough terrain escape algorithm 923. The rough terrain escape algorithm 923 may be stored in the processor 90 or in the memory 91.

For example, the rough terrain escape algorithm 923 may be configured to vibrate the motor 30, which rotates the drive wheel 20 stuck on the rough terrain, and rotate the motor 30 in one direction. When the processor 90 executes the rough terrain escape algorithm 923, the autonomous mobile robot 1 may escape from the rough terrain and drive normally.

According to one embodiment, the processor 90 may be configured in various ways as long as it can control the autonomous mobile robot 1. For example, the processor 90 may be implemented as a microprocessor, a graphics-processing unit (GPU), an artificial intelligence (AI) processor, a neural processing unit (NPU), or a time controller (TCON). However, the processor 90 is not limited thereto, and may include one or more of a central processing unit (CPU), a micro controller unit (MCU), a micro processing unit (MPU), a controller, an application processor (AP), a communication processor (CP), and an advanced reduced instruction set computing (RISC) machine (ARM) processor or may be defined as a corresponding term. In addition, the processor 90 may be implemented as a system on chip (SoC) or a large scale integration (LSI) in which a processing algorithm is built therein, or may be implemented as an application specific integrated circuit (ASIC) type or a field programmable gate array (FPGA) type.

The memory 91 may store various software programs, application software, data, etc. required for the autonomous driving of the autonomous mobile robot 1. For example, the memory 91 may store an autonomous driving algorithm 92, the rough terrain escape algorithm 923, and a motor control algorithm 93.

In addition, the memory 91 may store at least one instruction related to the autonomous mobile robot 1. The memory 91 may store an operating system (O/S) for driving the autonomous mobile robot 1.

The memory 91 may include a semiconductor memory such as a flash memory and the like or a magnetic storage medium such as a hard disk and the like.

On the other hand, in this disclosure, the term “memory 91” may be used to include a memory, a read-only memory (ROM) within the processor 90, a random access memory (RAM), or a memory card (e.g., a micro secure digital (SD) card, a memory stick) mounted on the autonomous mobile robot 1.

The processor 90 may include one or multiple processors. For example, the processor 90 may perform an operation of the autonomous mobile robot 1 according to one or more embodiments of the disclosure by executing at least one instruction stored in the memory 91.

FIG. 8 is a diagram illustrating the relationship between an autonomous driving algorithm 92 and a motor control algorithm 93 of an autonomous mobile robot 1 according to one or more embodiments of the disclosure.

Referring to FIG. 8, the processor 90 of the autonomous mobile robot 1 according to one or more embodiments of the disclosure may execute an autonomous driving algorithm 92.

The autonomous driving algorithm 92 may include a general driving algorithm 921 and a rough terrain recognition algorithm 922.

The general driving algorithm 921 may be configured so that the processor 90 controls the sensor 60 and the motors 30 of the autonomous mobile robot 1 to perform autonomous driving. For example, when the general driving algorithm 921 is executed, the processor 90 may use the sensor 60 to recognize surrounding information and control the motors 30 using this information to enable the autonomous mobile robot 1 to move to a target point.

The rough terrain recognition algorithm 922 may be configured to recognize whether the autonomous mobile robot 1 is stuck on the rough terrain. For example, when the current position of the autonomous mobile robot 1, as recognized by the sensor 60, remains unchanged while the autonomous mobile robot 1 is autonomously driving to the target point, the rough terrain recognition algorithm 922 may recognize that the autonomous mobile robot 1 is stuck on the rough terrain.

The rough terrain recognition algorithm 922 may be included in the general driving algorithm 921. For example, while executing the general driving algorithm 921, the processor 90 may use the sensor 60 to recognize the current position of the autonomous mobile robot 1 in real time. When the location of the autonomous mobile robot 1 remains unchanged or rotates in place instead of moving along the expected path, the processor 90 may recognize that the autonomous mobile robot 1 is stuck on the rough terrain. Furthermore, while the autonomous mobile robot 1 may not necessarily be completely stuck on the rough terrain, the rough terrain recognition algorithm 922 may also be able to identify variances in the travel of the autonomous mobile robot 1 to identify encounters with rough terrain. For example, the autonomous mobile robot 1 may encounter terrain that causes the autonomous mobile robot 1 to operate at a reduced velocity or requires more power to operate at a desired velocity, and as such, the rough terrain recognition algorithm 922 may also identify such situations as requiring corrective action via, for example, the rough terrain escape algorithm 923.

When it is recognized that the autonomous mobile robot 1 is stuck on the rough terrain, the processor 90 may transmit rough terrain recognition information to the motor control algorithm 93. Here, the rough terrain recognition information may refer to a state in which the autonomous mobile robot 1 is stuck on the rough terrain and is at a standstill or unable to move along the expected path, as well as being unable to move along the expected path at a desired velocity or with a desired power output.

The motor control algorithm 93 may include a motor driver 80 and a rough terrain escape algorithm 923.

The motor driver 80 may be configured to receive a target rotation speed from the autonomous driving algorithm 92 and rotate the motor 30 according to the received target rotation speed. In addition, the motor driver 80 may receive a motor rotation speed from the motor 30 and transmit the motor rotation speed to the autonomous driving algorithm 92. Here, the motor rotation speed may refer to the actual rotation speed of the motor 30 measured by a motor sensor 39 (operation See FIG. 21) disposed in the motor 30, for example, a Hall sensor or an encoder. The motor driver 80 may control the motor 30 through PID control so that the motor rotation speed matches the target rotation speed.

When receiving rough terrain recognition information from the rough terrain recognition algorithm 922 of the autonomous driving algorithm 92, the rough terrain escape algorithm 923 may change a gain value of the motor driver 80 so that the motor driver 80 may rotate the drive wheel 20 while vibrating the drive wheel 20 up and down. For example, the rough terrain escape algorithm 923 may change the gain value of the motor driver 80 to cause the drive wheel 20 to rotate in one direction while vibrating up and down. The gain value that allows the drive wheel 20 to rotate in one direction while vibrating it up and down may be stored in the memory 91.

The motor 30 may be configured to rotate according to a signal output from the motor driver 80. In addition, the motor 30 may include a motor sensor 39 configured to measure the rotation speed of the motor 30.

According to one embodiment, the general driving algorithm 921 may transmit a target rotation speed to the motor driver 80 of the motor control algorithm 93. The motor driver 80 of the motor control algorithm 93 may rotate the motor 30 at the target rotation speed.

The motor 30 may rotate according to a signal transmitted from the motor driver 80. The motor sensor 39 disposed in the motor 30 may detect the motor rotation speed and transmit the detected motor rotation speed to the motor driver 80. The motor driver 80 may transmit the motor rotation speed received from the motor 30 to the autonomous driving algorithm 92. The motor driver 80 may control the rotation speed of the motor 30 to match the target rotation speed through the PID control.

The processor 90 may recognize that autonomous mobile robot 1 is stuck on the rough terrain through the rough terrain recognition algorithm 922 while performing autonomous driving by executing the general driving algorithm 921. In this case, the rough terrain recognition algorithm 922 may transmit the rough terrain recognition information to the motor control algorithm 93. Then, the rough terrain escape algorithm 923 of the motor control algorithm 93 may change the gain value of the motor driver 80.

Then, the motor driver 80 may control the motor 30 so that the motor 30 rotates in one direction while vibrating. Then, the drive wheel 20, which is disposed integrally with the motor 30, may rotate in one direction while vibrating up and down and, thereby escaping from the rough terrain.

When the processor 90 detects a change in the position of the autonomous mobile robot 1 through the sensor 60, the processor 90 may recognize that the autonomous mobile robot 1 has exited the rough terrain and, using the general driving algorithm 921, enable the autonomous mobile robot 1 to perform autonomous driving.

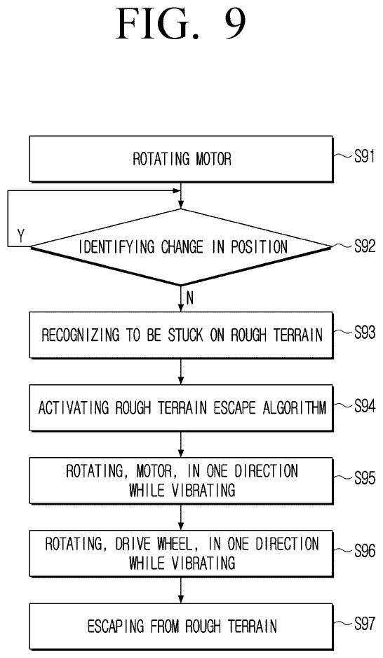

Hereinafter, a method for an autonomous mobile robot 1 according to one or more embodiments of the disclosure to escape from a rough terrain will be described in detail with reference to FIG. 9.

FIG. 9 is a flowchart illustrating a method for an autonomous mobile robot 1 to escape from a rough terrain according to one or more embodiments of the disclosure.

First, the processor 90 of the autonomous mobile robot 1 may control the motor driver 80 to rotate the motors 30 (operation S91). The processor 90 may control the motor driver 80 using an autonomous driving algorithm 92. When the motor 30 rotates, the drive wheel 20 coupled to the motor 30 may rotate, so the autonomous mobile robot 1 may move.

Next, the processor 90 may identify whether the position of the autonomous mobile robot 1 is being changed (operation S92). For example, the processor 90 may identify whether the autonomous mobile robot 1 is moving to an expected position using the sensor 60. According to one embodiment, the processor 90 may detect the position of the autonomous mobile robot 1 using at least one of the plurality of camera sensors 61, the LIDAR sensor 62, and the IMU sensor.

When the autonomous mobile robot 1 moves to the expected position (operation S92-Y), the processor 90 may perform autonomous driving using the general driving algorithm 921.

When the position of the autonomous mobile robot 1 remains unchanged (operation S92-N), the processor 90 may recognize that the autonomous mobile robot 1 is stuck on a rough terrain (or is encountering rough terrain) (operation S93). For example, when the motors 30 are rotating but the position of the autonomous mobile robot 1 detected by the sensor 60 remains unchanged, the processor 90 may recognize that the autonomous mobile robot 1 is stuck on the rough terrain. Alternatively, when the motors 30 are rotating but the movement path of the autonomous mobile robot 1 detected by the sensor 60 differs from the expected path, the processor 90 may recognize that the autonomous mobile robot 1 is stuck on the rough terrain.

When the autonomous mobile robot 1 is recognized as being stuck on the rough terrain, the processor 90 may activate the rough terrain escape algorithm 923 (operation S94). For example, the rough terrain escape algorithm 923 may change the gain value of the motor driver 80 to enable the autonomous mobile robot 1 to escape from the rough terrain.

When the rough terrain escape algorithm 923 is activated and the gain value of the motor driver 80 is changed, the motor 30 may vibrate and rotate in one direction (operation S95). Here, the vibration of the motor 30 may indicate that the rotation direction of the rotor of the motor 30 rapidly continuously changes between forward and reverse directions. For example, the vibration of the motor 30 may indicate that the rotation direction of the rotor rapidly changes from clockwise to counterclockwise and then from counterclockwise to clockwise within a certain angular range.

When the motor 30 vibrates and rotates in one direction, the drive wheel 20 on which the motor 30 is disposed may vibrate and rotate in one direction (operation S96). When the drive wheel 20 vibrates and rotates in one direction, the drive wheel 20 may escape from the rough terrain (operation S97). Therefore, when the motor 30 vibrates and rotates in one direction, the drive wheel 20 may escape from the rough terrain.

For example, when the motor 30 vibrates and rotates in one direction, moments in which the direction in which the drive wheel 20 moves and the direction in which the motor 30 rotates become opposite to each other may repeatedly occur. At the moment when the moving direction of the drive wheel 20 and the rotation direction of the motor 30 become opposite to each other, the drive wheel 20 may bounce upward due to resistance. Subsequently, the drive wheel 20 may descend again due to the weight of the autonomous mobile robot 1. In addition, when the motor 30 vibrates and rotates in one direction, the drive wheel 20 may be lifted upward due to the resistance of the rough terrain and then descend again due to its own weight. This motion may allow the drive wheel 20 to escape from the rough terrain.

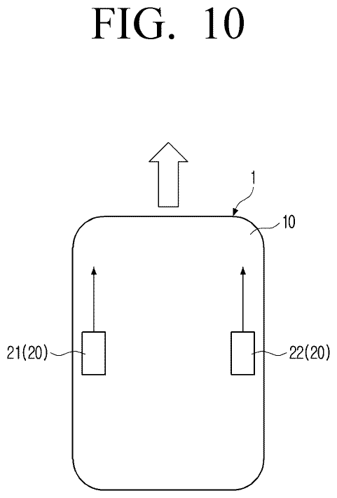

Hereinafter, with reference to FIGS. 10 to 19, various cases in which the rough terrain recognition algorithm 922 of the autonomous mobile robot 1 according to one or more embodiments of the disclosure recognizes a rough terrain 100 will be described in detail.

For reference, FIGS. 10 to 19 conceptually illustrate the body 10 and the pair of drive wheels 20 of the autonomous mobile robot 1 to illustrate a case in which the autonomous mobile robot 1 is stuck on the rough terrain 100. Furthermore, a pair of black arrows indicated on the pair of drive wheels 20 in FIGS. 10 to 19 indicate the rotation speed of the drive wheels 20.

First, with reference to FIGS. 10, 11, and 12, a case in which the autonomous mobile robot 1 is stuck on the rough terrain while moving straight will be described.

FIG. 10 is a conceptual diagram illustrating a state in which an autonomous mobile robot 1 is moving straight according to one or more embodiments of the disclosure.

As illustrated in FIG. 10, when the pair of drive wheels 20, i.e., the left drive wheel 21 and the right drive wheel 22, rotate in the same direction at the same rotation speed, the autonomous mobile robot 1 may move straight. For example, the autonomous mobile robot 1 may move straight forward as indicated by the larger arrow.

While the autonomous mobile robot 1 moves straight, the processor 90 may identify changes in the position of the autonomous mobile robot 1 through the sensor 60. In addition, the processor 90 may identify that the autonomous mobile robot 1 moves to an expected position through the sensor 60. Here, the expected position may refer to a position that the autonomous mobile robot 1 will reach, determined by the processor 90 at regular time intervals when the autonomous mobile robot 1 performs autonomous driving using the general driving algorithm 921.

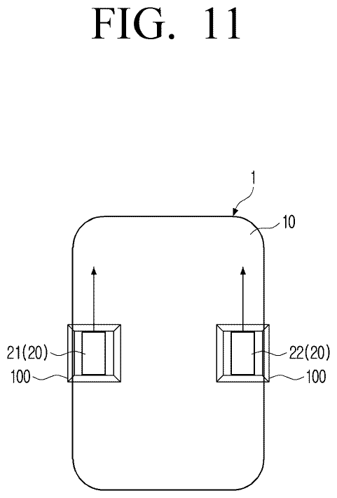

A state in which a pair of drive wheels 20 of the autonomous mobile robot 1 has stuck on the rough terrain 100 while autonomously driving in a straight line is illustrated in FIG. 11.

FIG. 11 is a conceptual diagram illustrating a state in which a pair of drive wheels 20 of an autonomous mobile robot 1, while driving in a straight line, have stuck on a rough terrain 100 according to one or more embodiments of the disclosure.

Referring to FIG. 11, the pair of drive wheels 20 rotate in the same direction at the same rotation speed. However, because the pair of drive wheels 20 have stuck on the rough terrain 100, the autonomous mobile robot 1 may not move straight and may remain in place. In other words, the position of the autonomous mobile robot 1 may not change. As illustrated in FIG. 11, when the position of the autonomous mobile robot 1 does not change, the processor 90 may recognize that the pair of drive wheels 20, i.e., the left drive wheel 21 and the right drive wheel 22, of the autonomous mobile robot 1 has stuck on the rough terrain 100.

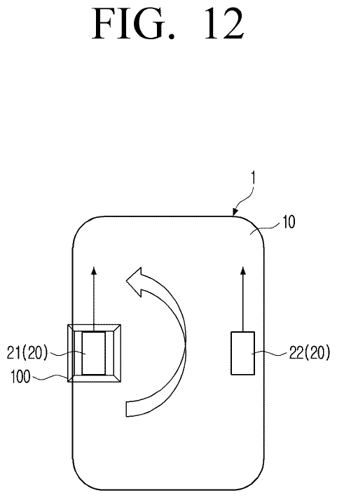

A state in which the left drive wheel 21 of the autonomous mobile robot 1 gets stuck on the rough terrain 100 while autonomously driving is illustrated in FIG. 12.

FIG. 12 is a conceptual diagram illustrating a state in which a left drive wheel 21 of an autonomous mobile robot 1, moving in a straight line, has stuck on a rough terrain 100 according to one or more embodiments of the disclosure.

Referring to FIG. 12, the pair of drive wheels 20 rotate in the same direction at the same rotation speed, but the left drive wheel 21 is stuck on the rough terrain 100, while the right drive wheel 22 is not stuck on the rough terrain 100. In this case, the left drive wheel 21 is stuck on the rough terrain 100 and may not move, but the right drive wheel 22 may move. Therefore, the autonomous mobile robot 1 may rotate to the left about the left drive wheel 21, as indicated by the white arrow.

When the pair of drive wheels 20 rotate in the same direction at the same rotation speed, the expected position of the autonomous mobile robot 1 may be forward. However, when the position of the autonomous mobile robot 1 detected by the sensor 60 changes, but the position of the autonomous mobile robot 1 is not the expected position and rotates to the left, the processor 90 may recognize that the left drive wheel 21 of the autonomous mobile robot 1 has stuck on the rough terrain 100.

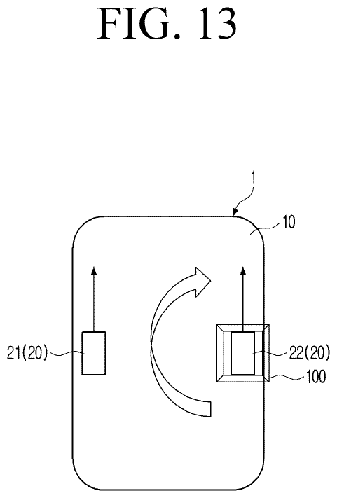

A state in which the right drive wheel 22 of the autonomous mobile robot 1 gets stuck on the rough terrain 100 while autonomously driving is illustrated in FIG. 13.

FIG. 13 is a conceptual diagram illustrating a state in which a right drive wheel 22 of an autonomous mobile robot 1, moving straight, has stuck on a rough terrain 100 according to one or more embodiments of the disclosure.

Referring to FIG. 13, the pair of drive wheels 20 rotate in the same direction at the same rotation speed, but the right drive wheel 22 is stuck on the rough terrain 100, while the left drive wheel 21 is not stuck on the rough terrain 100. In this case, the right drive wheel 22 is stuck on the rough terrain 100 and may not move, but the left drive wheel 21 may move. Therefore, the autonomous mobile robot 1 may rotate to the right about the right drive wheel 22, as indicated by the white arrow.

When the pair of drive wheels 20 rotate in the same direction at the same rotation speed, the expected position of the autonomous mobile robot 1 may be forward. However, when the position of the autonomous mobile robot 1 detected by the sensor 60 changes, but the position of the autonomous mobile robot 1 is not the expected position and rotates to the right, the processor 90 may recognize that the right drive wheel 22 of the autonomous mobile robot 1 has stuck on the rough terrain 100.

The autonomous mobile robot 1 according to one or more embodiments of the disclosure may autonomously drive along a curved path that bends to the right or left. In other words, the autonomous mobile robot 1 according to one or more embodiments of the disclosure may turn right or left.

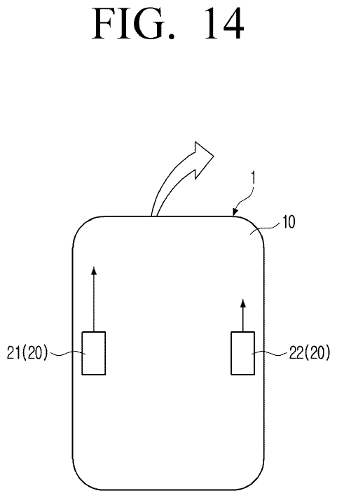

FIG. 14 is a conceptual diagram illustrating a state in which an autonomous mobile robot is turning right according to one or more embodiments of the disclosure.

As illustrated in FIG. 14, when the rotation speed of the left drive wheel 21 is greater than the rotation speed of the right drive wheel 22, the autonomous mobile robot 1 may move along a curved path that curves to the right. For example, the autonomous mobile robot 1 may move in the right direction while drawing a curve, as indicated by the white arrow.

While the autonomous mobile robot 1 moves along the curve, the processor 90 may identify changes in the position of the autonomous mobile robot 1 through the sensor 60. In addition, the processor 90 may identify that the autonomous mobile robot 1 is moving to the expected position through the sensor 60. The expected position may be on the expected path of the autonomous mobile robot 1 having a first curvature defined by the difference between the rotation speed of the left drive wheel 21 and the rotation speed of the right drive wheel 22.

When the pair of drive wheels 20 of the autonomous mobile robot 1 are stuck on the rough terrain 100 while autonomously driving along the curve, the autonomous mobile robot 1 may not move, and thus the position of the autonomous mobile robot 1 may not change. When the position of the autonomous mobile robot 1 remains unchanged, the processor 90 may recognize that the pair of drive wheel 20 of the autonomous mobile robot 1 has stuck on the rough terrain 100.

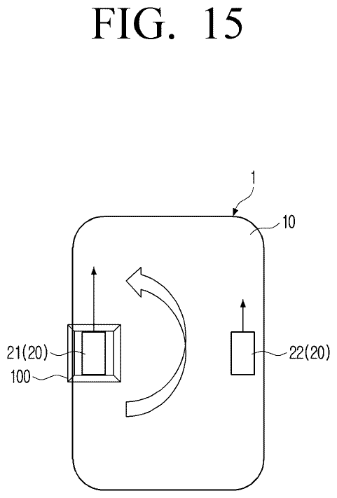

FIG. 15 illustrates a state in which the left drive wheel 21 of the autonomous mobile robot 1 is stuck on the rough terrain 100 while making a right turn as illustrated in FIG. 14.

FIG. 15 is a conceptual diagram illustrating a state in which a left drive wheel 21 of an autonomous mobile robot 1, turning right, has stuck on a rough terrain 100 according to one or more embodiments of the disclosure.

Referring to FIG. 15, the left drive wheel 21 rotates at a faster speed than the right drive wheel 22, but the left drive wheel 21 is stuck on the rough terrain 100 and the right drive wheel 22 is not stuck on the rough terrain 100. In this case, the left drive wheel 21 is stuck on the rough terrain 100 and may not move, but the right drive wheel 22 may move. Therefore, the autonomous mobile robot 1 may rotate to the left about the left drive wheel 21, as indicated by the white arrow.

When the rotation speed of the left drive wheel 21 is faster than the rotation speed of the right drive wheel 22, the autonomous mobile robot 1 may turn right along the curved path having the first curvature defined by the difference between the rotation speed of the left drive wheel 21 and the rotation speed of the right drive wheel 22, as illustrated in FIG. 14. Accordingly, the expected position of the autonomous mobile robot 1 may be located on a curve that has the first curvature and is bent to the right. However, when the position of the autonomous mobile robot 1 detected by the sensor 60 is not the expected position but a different position, for example, a position where the autonomous mobile robot 1 rotates leftward about the left drive wheel 21, the processor 90 may recognize that the left drive wheel 21 of the autonomous mobile robot 1 has stuck on the rough terrain 100.

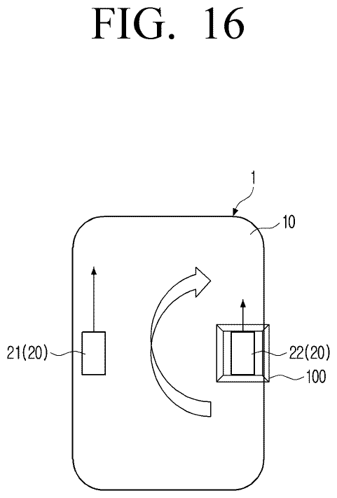

A state in which the right drive wheel 22 of gets stuck on the rough terrain 100 while the autonomous mobile robot 1 is turning right as illustrated in FIG. 14 is illustrated in FIG. 16.

FIG. 16 is a conceptual diagram illustrating a state in which a right drive wheel 22 of an autonomous mobile robot 1, turning right, has stuck on a rough terrain 100 according to one or more embodiments of the disclosure.

Referring to FIG. 16, the left drive wheel 21 rotates at a faster speed than the right drive wheel 22, but the right drive wheel 22 is stuck on the rough terrain 100 and the left drive wheel 21 is not stuck on the rough terrain 100. In this case, the right drive wheel 22 is stuck on the rough terrain 100 and may not move, but the left drive wheel 21 may move. Therefore, the autonomous mobile robot 1 may turn to the right about the right drive wheel 22, as indicated by the white arrow.

When the rotation speed of the left drive wheel 21 is faster than the rotation speed of the right drive wheel 22, the autonomous mobile robot 1 may turn right along a curve having the first curvature defined by the difference between the rotation speeds of the left drive wheel 21 and the right drive wheel 22, as illustrated in FIG. 14. Accordingly, the expected position of the autonomous mobile robot 1 may be located on the curve that has the first curvature and is bent to the right. However, when the position of the autonomous mobile robot 1 detected by the sensor 60 is not the expected position but is located at a different position, for example, a position where the autonomous mobile robot 1 rotates along a curve having a second curvature in a rightward direction about the right drive wheel 22, the processor 90 may recognize that the right drive wheel 22 of the autonomous mobile robot 1 has stuck on the rough terrain 100. The second curvature may be greater than the first curvature.

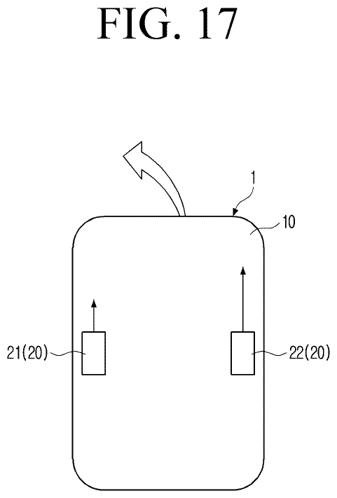

FIG. 17 is a conceptual diagram illustrating a state in which an autonomous mobile robot 1 is turning left according to one or more embodiments of the disclosure.

As illustrated in FIG. 17, when the rotation speed of the right drive wheel 22 is faster than the rotation speed of the left drive wheel 21, the autonomous mobile robot 1 may move along a curved path that curves to the left. For example, the autonomous mobile robot 1 may move in a left direction while drawing a curved path, as indicated by the white arrow.

While the autonomous mobile robot 1 moves along the curve, the processor 90 may identify changes in the position of the autonomous mobile robot 1 through the sensor 60. In addition, the processor 90 may identify that the autonomous mobile robot 1 is moving to the expected position through the sensor 60. The expected position may be on the expected path of the autonomous mobile robot 1 having a third curvature defined by the processor 90 based on the difference between the rotation speed of the left drive wheel 21 and the rotation speed of the right drive wheel 22.

When the pair of drive wheels 20 of the autonomous mobile robot 1 are stuck on the rough terrain 100 while autonomously driving along the curve path as illustrated in FIG. 17, the autonomous mobile robot 1 may not move, and thus the position of the autonomous mobile robot 1 may not change. When the position of the autonomous mobile robot 1 remains unchanged, the processor 90 may recognize that the pair of drive wheel 20 of the autonomous mobile robot 1 has stuck on the rough terrain 100.

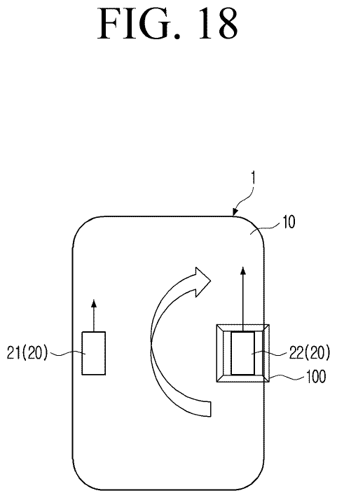

FIG. 18 illustrates a state in which the right drive wheel 22 of the autonomous mobile robot 1 is stuck on the rough terrain 100 while making a left turn, as illustrated in FIG. 17.

FIG. 18 is a conceptual diagram illustrating a state in which a right drive wheel 22 of an autonomous mobile robot 1, turning left, has stuck on a rough terrain 100 according to one or more embodiments of the disclosure.

Referring to FIG. 18, the right drive wheel 22 rotates at a faster speed than the left drive wheel 21, but the right drive wheel 22 is stuck on the rough terrain 100 and the left drive wheel 21 is not stuck on the rough terrain 100. In this case, the right drive wheel 22 is stuck on the rough terrain 100 and may not move, but the left drive wheel 21 may move. Therefore, the autonomous mobile robot 1 may rotate to the right about the right drive wheel 22, as indicated by the white arrow.

When the rotation speed of the right drive wheel 22 is faster than the rotation speed of the left drive wheel 21, the autonomous mobile robot 1 may turn left along a curve having a third curvature defined by the difference between the rotation speeds of the right drive wheel 22 and the left drive wheel 21, as illustrated in FIG. 17. Accordingly, the expected position of the autonomous mobile robot 1 may be located on the expected path that has the third curvature and is bent to the left. However, when the position of the autonomous mobile robot 1 detected by the sensor 60 is not the expected position but a different position, for example, a position where the autonomous mobile robot 1 rotates rightward about the right drive wheel 22, the processor 90 may recognize that the right drive wheel 22 of the autonomous mobile robot 1 has stuck on the rough terrain 100.

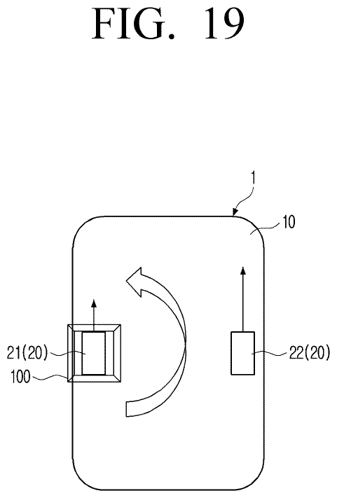

A state in which the left drive wheel 21 gets stuck on the rough terrain 100 while the autonomous mobile robot 1 is turning left as illustrated in FIG. 17 is illustrated in FIG. 19.

FIG. 19 is a conceptual diagram illustrating a state in which a left drive wheel 21 of an autonomous mobile robot 1, turning left, has stuck on a rough terrain 100 according to one or more embodiments of the disclosure.

Referring to FIG. 19, the right drive wheel 22 rotates at a faster speed than the left drive wheel 21, but the left drive wheel 21 is stuck on the rough terrain 100 and the right drive wheel 22 is not stuck on the rough terrain 100. In this case, the left drive wheel 21 is stuck on the rough terrain 100 and may not move, but the right drive wheel 22 may move. Therefore, the autonomous mobile robot 1 may rotate to the left about the left drive wheel 21, as indicated by the white arrow.

When the rotation speed of the right drive wheel 22 is faster than the rotation speed of the left drive wheel 21, the autonomous mobile robot 1 may turn left along a curved path having the third curvature defined by the difference between the rotation speeds of the left drive wheel 21 and the right drive wheel 22, as illustrated in FIG. 17. Accordingly, the expected position of the autonomous mobile robot 1 may be located on an expected path that has the third curvature and is bent to the left. However, when the position of the autonomous mobile robot 1 detected by the sensor 60 is not the expected position but is at a different position, for example, a position where the autonomous mobile robot 1 rotates along a curve having a fourth curvature in a leftward direction about the left drive wheel 21, the processor 90 may recognize that the left drive wheel 21 of the autonomous mobile robot 1 has stuck on the rough terrain 100. The fourth curvature may be greater than the third curvature.

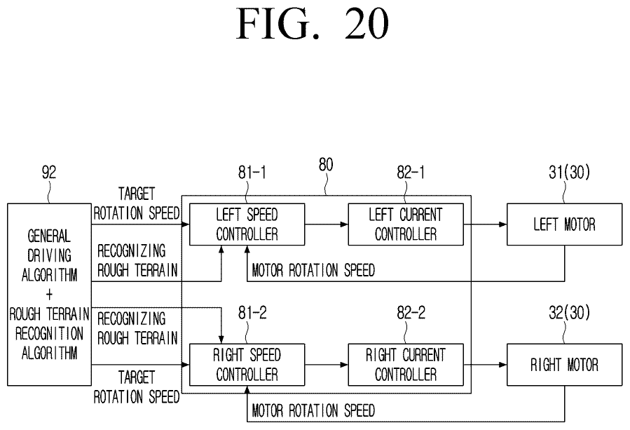

Hereinafter, a method for controlling motors 30 by an autonomous driving algorithm 92 of an autonomous mobile robot 1 according to one or more embodiments of the disclosure will be described in detail with reference to FIGS. 20 to 27.

FIG. 20 is a control block diagram of a pair of motors 30 of an autonomous mobile robot 1 according to one or more embodiments of the disclosure.

An autonomous driving algorithm 92 may transmit a target rotation speed to the motor driver 80. For example, the autonomous driving algorithm 92 may transmit the target rotation speed of the left motor 31 to a left speed controller 81-1 of the motor driver 80. Then, a signal corresponding to the target rotation speed may be transmitted to the left motor 31 via the left speed controller 81-1 and a left current controller 82-1. Accordingly, the left motor 31 may rotate in response to the target rotation speed. The left motor 31 may feedback a signal corresponding to the actual motor rotation speed to the left speed controller 81-1. Then, the left speed controller 81-1 may receive the feedback signal and control the left motor 31 so that the rotation speed of the left motor 31 matches the target rotation speed. The left speed controller 81-1 may be implemented as a PID controller or a PI controller.

In addition, the autonomous driving algorithm 92 may transmit a target rotation speed of the right motor 32 to a right speed controller 81-2 of the motor driver 80. Then, a signal corresponding to the target rotation speed may be transmitted to the right motor 32 via the right speed controller 81-2 and a right current controller 82-2. Accordingly, the right motor 32 may rotate in response to the target rotation speed. The right motor 32 may feedback a signal corresponding to the actual motor rotation speed to the right speed controller 81-2. Then, the right speed controller 81-2 may receive the feedback signal and control the right motor 32 so that the rotation speed of the right motor 32 matches the target rotation speed. The right speed controller 81-2 may be configured in the same manner as the left speed controller 81-1. For example, the right speed controller 81-2 may be implemented as a PID controller or a PI controller.

In one or more example embodiments, instead of or in addition to using the sensors to determine whether the autonomous mobile robot 1 is stuck on a rough terrain, the processor 90 may also utilize the target rotation speed of the wheels to determine whether the autonomous mobile robot 1 is stuck on a rough terrain. For example, the right speed controller 81-2 may receive the feedback signal that indicates that the rotation speed of the right motor 32 does not match the target rotation speed. In response to this first feedback signal, the right speed controller 81-2 may control the right motor 32 to reach the target rotation speed. Thereafter, the right speed controller may receive a second feedback signal that indicates that the rotation speed of the right motor 32 still does not match the target rotation speed. As a result of this second feedback signal, the processor 90 may determine that the right wheel is stuck on a rough terrain.

Hereinafter, when the left speed controller 81-1 and the right speed controller 81-2 are configured as PID controllers, a method for the speed controller 81 to match the rotation speed of the motor 30 to the target rotation speed will be described with reference to FIGS. 21 to 24.

FIG. 21 is a control block diagram of a motor 30 when a speed controller 81 is implemented as a PID controller.

Referring to FIG. 21, a target rotation speed may be input to the speed controller 81. For example, the target rotation speed may be input to an error calculator 81a of the speed controller 81. An error value calculated by the error calculator 81a may be input to the PID controller 81b.

Initially, the motor rotation speed fed back from the motor 30 is zero (0), so the input to the PID controller 81b may be equal to the target rotation speed. When the motor 30 rotates by the PID controller 81b and the current controller 82, the motor rotation speed of the motor 30 may be fed back to the speed controller 81, i.e., the error calculator 81a.

When the motor 30 rotates, an error value may be input to the PID controller 81b. Here, the error value may be a value obtained by subtracting the motor rotation speed from the target rotation speed. In other words, the error value =target rotation speed—motor rotation speed. The PID controller 81b may control the motor 30 so that the error value becomes zero (0).

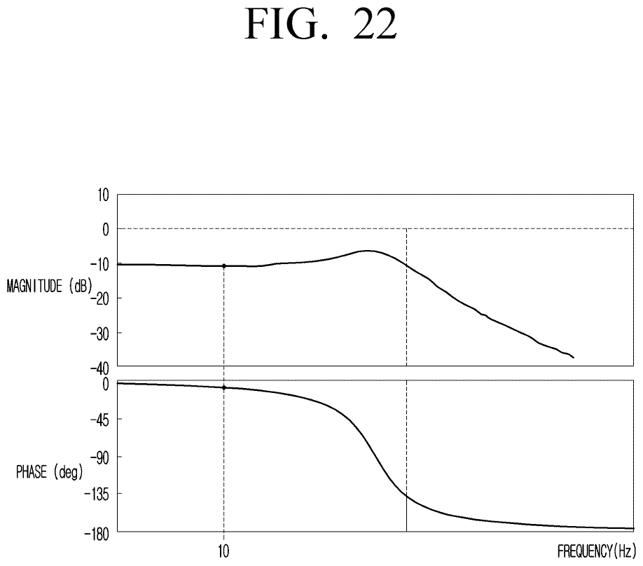

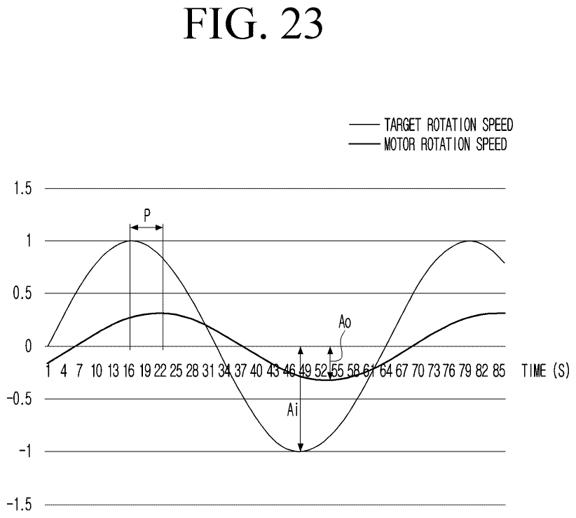

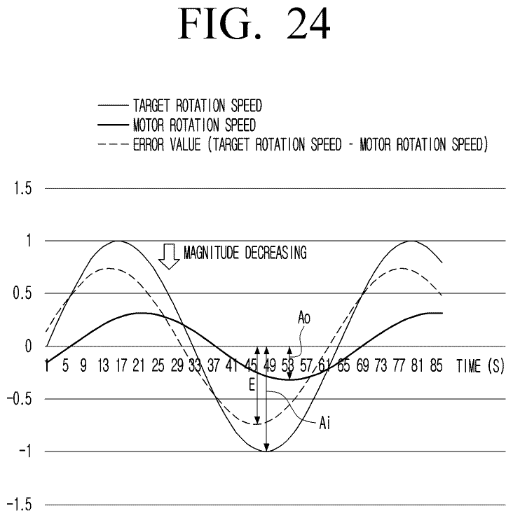

FIG. 22 is a Bode plot illustrating a speed controller 81 of a motor driver 80 of an autonomous mobile robot 1 according to one or more embodiments of the disclosure. FIG. 23 is a graph illustrating change in the magnitude and phase of a signal with a frequency of 10 Hz in the Bode plot of FIG. 22 over time. FIG. 24 is a graph with error values added to the graph of FIG. 23.

In FIG. 22, the horizontal axis represents frequency (unit: Hz), and the vertical axis of the upper graph represents the magnitude (unit: dB) of the output (motor rotation speed) relative to the input (target rotation speed). The vertical axis of the lower graph represents the phase (unit: degrees).

For example, when the frequency of the signal is 10 Hz, the magnitude representing the output relative to the input is −10 dB (approximately 0.31 times), and the phase is approximately −28 degrees.

When the magnitude of the output relative the input and the phase of FIG. 22 are expressed over time, they may be depicted as in FIG. 23. In FIG. 23, the horizontal axis represents time, and the vertical axis represents a multiple. P represents the phase difference between the input and the output, Ai represents the magnitude of the input, and Ao represents the magnitude of output.

Referring to FIG. 23, when the maximum target rotation speed Ai is 1, the maximum rotation speed Ao of the motor 30 is 0.31. Therefore, the rotation speed of the motor 30 may be reduced by 0.31 times compared to the target rotation speed.

Referring to FIG. 24, the error value may become smaller than the target rotation speed over time. Therefore, as time passes, the error value input to the PID controller 81b may gradually decrease and converge to zero (0). Then, the motor rotation speed may match the target rotation speed. In other words, when the gain value of the PID controller 81b is less than 0 dB, the error value may converge to zero (0), so that the motor rotation speed of the motor 30 may match the target rotation speed.

When the autonomous mobile robot 1 according to one or more embodiments of the disclosure autonomously drives, the gain value of the PID controller 81b as described above may be set to 0 dB or less so that the motor rotation speed may match the target rotation speed, thereby enabling normal driving.

When the rough terrain escape algorithm 923 adjusts the gain value of the PID controller 81b, the magnitude of the output relative to the input of the PID controller 81b may be made larger than 0 dB.

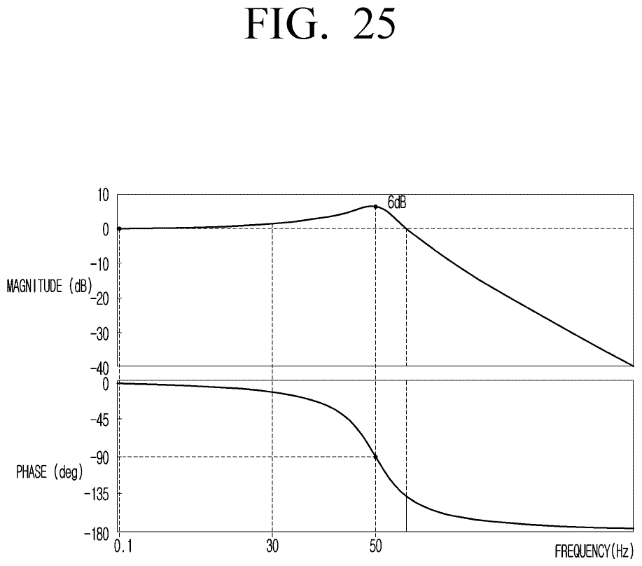

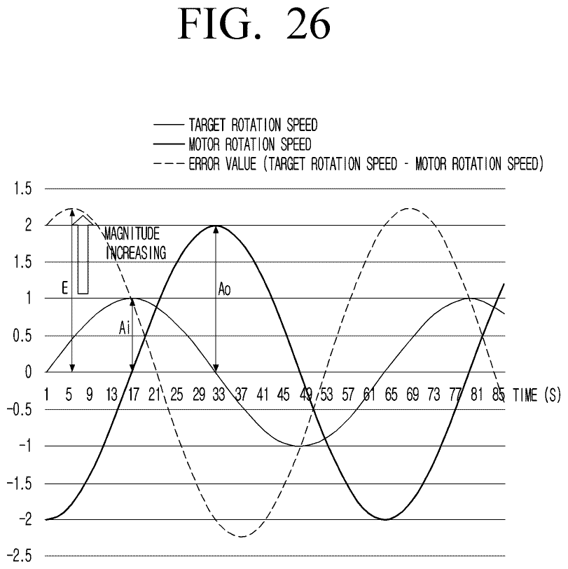

Referring to FIGS. 25 and 26, a case where the magnitude of the output relative to the input of the PID controller 81b is greater than 0 dB will be described.

FIG. 25 is a Bode plot illustrating a speed controller 81 of a motor driver 80 of an autonomous mobile robot 1 according to one or more embodiments of the disclosure. FIG. 26 is a graph illustrating changes in the magnitude and phase of a signal with a frequency of 50 Hz in the Bode plot of FIG. 25 and the error value over time.

In FIG. 25, the horizontal axis represents frequency (unit: Hz), and the vertical axis of the upper graph represents the magnitude (unit: dB) of the output (motor rotation speed) relative to the input (target rotation speed). The vertical axis of the lower graph represents the phase (unit: degrees).

For example, when the frequency of the signal is 50 Hz, the magnitude of the output relative to the input is 6 dB (approximately 1.99 times), and the phase is approximately −90 degrees.

When the magnitude and phase of the output relative the input in FIG. 25 may be expressed over time, they may be depicted as in FIG. 26. In FIG. 26, the horizontal axis represents time, and the vertical axis represents a multiple. Ai represents the magnitude of the input, and Ao represents the magnitude of the output.

Referring to FIG. 26, when the maximum target rotation speed Ai of the input is 1, the maximum rotation speed Ao of the motor 30 of the output is 1.99. In other words, the motor rotation speed of the motor 30 may increase by 1.99 times the target rotation speed. Therefore, because the feedback motor rotation speed is greater than the target rotation speed, the error value input to the PID controller 81b may be greater than the target rotation speed.

When the error value input to the PID controller 81b exceeds the target rotation speed, the signal output to the motor 30 may increase. This increase in signal input to the motor 30 may cause the motor 30 to vibrate. Therefore, even when a small target rotation speed is input to the PID controller 81b, a signal with a large value may be input to the motor 30, so the motor 30 may vibrate.

However, when only a signal that causes the motor 30 to vibrate, as described above, is input to the PID controller 81b, the motor 30 may only vibrate and not rotate in one direction. Then, the drive wheel 20 coupled to the motor 30 does not rotate, so the autonomous mobile robot 1 may not move. To enable the autonomous mobile robot 1 to move, an additional signal that causes the motor 30 to rotate in one direction may be input to the PID controller 81b.

The magnitude of a signal capable of rotating the motor 30 in one direction may be 0 dB or less, while the magnitude of a signal capable of vibrating the motor 30 may be greater than 0 dB. Referring to FIG. 25, a signal with a frequency below 1 Hz may have a magnitude of 0 dB, while a signal with a frequency above 30 Hz may have a magnitude of 1 dB or greater.

Therefore, to cause the motor 30 to rotate in one direction and vibrate simultaneously, a composite signal including a signal with a frequency below 1 Hz and a signal with a frequency above 30 Hz may be input to the PID controller 81 b. In other words, by inputting the composite signal including the motor rotation signal for rotating the motor 30 in one direction and the motor vibration signal for vibrating the motor 30 to the PID controller 81b of the motor driver 80, the motor 30 may rotate in one direction and vibrate simultaneously.

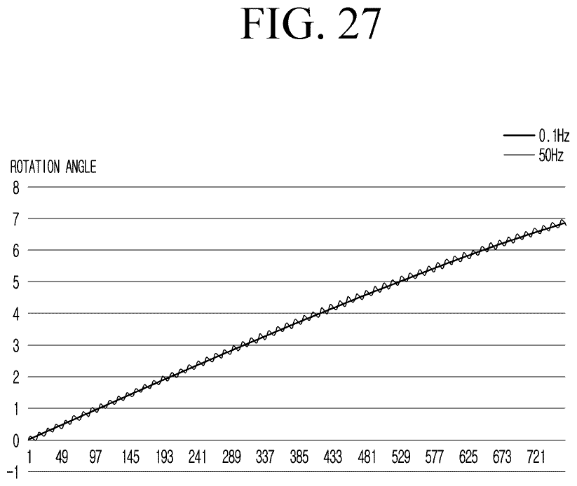

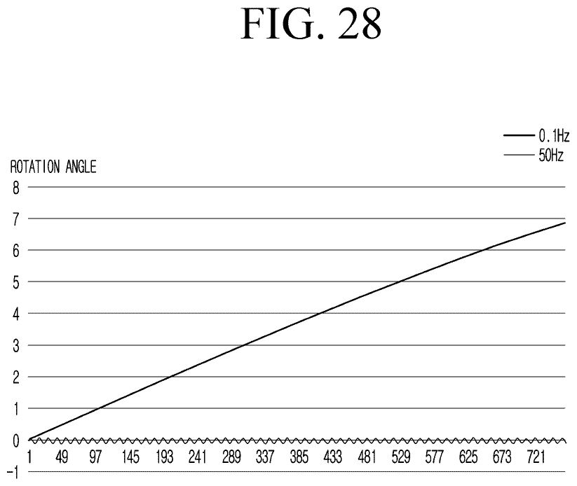

For example, as illustrated in FIGS. 27 and 28, a signal of 0.1 Hz may be used as the motor rotation signal that causes the motor 30 to rotate in one direction, and a signal of 50 Hz may be used as the motor vibration signal that causes the motor 30 to vibrate.

FIG. 27 is a graph illustrating a composite signal input to a PID controller 81b of a motor driver 80. FIG. 28 is a graph that separates and illustrates the composite signal of FIG. 27.

When a composite signal such as that illustrated in FIG. 27 is input to the PID controller 81b as a target rotation speed, the motor 30 may rotate in one direction while vibrating. Referring to FIG. 28, it can be seen that the signal of 0.1 Hz causes the motor 30 to rotate in one direction, and the signal of 50 Hz causes the motor 30 to vibrate in place.

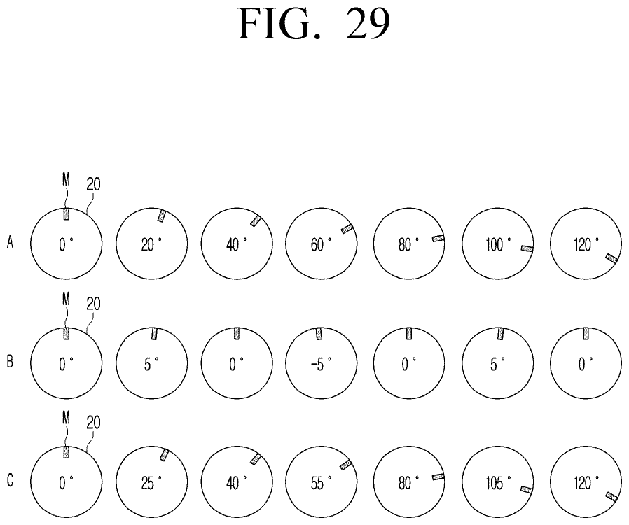

That the drive wheel 20 vibrates and rotates by the composite signal input to the PID controller 81b of the motor driver 80 will be described in detail with reference to FIG. 29,

FIG. 29 is a conceptual diagram illustrating rotation and vibration of a drive wheel 20 due to a composite signal input to a motor driver 80.

For reference, in FIG. 29, a motor 30 may be coupled to the drive wheel 20. Therefore, when the motor 30 rotates and vibrates, the drive wheel 20 may also rotate and vibrate integrally with the motor 30. In addition, in FIG. 29, row A represents a state in which the drive wheel 20 rotates in one direction due to the motor rotation signal. For example, row A may represent a state in which the drive wheel 20 rotates in one direction due to a signal having a frequency of 0.1 Hz. Row B may represent a state in which the drive wheel 20 vibrates due to the motor vibration signal. For example, row B may represent a state in which the drive wheel 20 vibrates due to a signal having a frequency of 50 Hz. Row C may represent a state in which the drive wheel 20 vibrates and rotates in one direction due to a composite signal combining the motor rotation signal and the motor vibration signal. For example, row C may represent a state in which the drive wheel 20 vibrates while rotating in one direction due to a composite signal that combines a signal having a frequency of 0.1 Hz and a signal having a frequency of 50 Hz.

In FIG. 29, referring to row A, the drive wheel 20 may rotate clockwise from the zero (0) degree position by the motor rotation signal. Row A illustrates a state in which a reference point M of the drive wheel 20 rotates clockwise by 20 degrees.

Referring to row B, the drive wheel 20 may vibrate clockwise and counterclockwise by 5 degrees based on the 0 degree position by the motor vibration signal. In detail, by the motor vibration signal, the reference point M of the drive wheel 20 may rotate clockwise by 5 degrees from the 0 degree position, then return to the 0 degree position, then rotate counterclockwise by −5 degrees, and then return to the 0 degree position, and this process may be repeated.

Referring to row C, the drive wheel 20 may rotate clockwise and vibrate at a magnitude of 5 degrees by the composite signal that combines the motor rotation speed and the motor vibration signal. Row C illustrates a state in which the reference point M of the drive wheel 20 rotates clockwise by 20 degrees and vibrates by 5 degrees.

In FIG. 29, although row B illustrates that drive wheel 20 vibrates once every 20 degrees, in reality, the drive wheel 20 may vibrate at shorter intervals. For example, when drive wheel 20 rotates by a signal of 0.1 Hz and vibrates by a signal of 50 Hz, because the motor vibration signal is 500 times faster than the motor rotation signal, when the drive wheel 20 rotates 20 degrees, the drive wheel 20 may vibrate left and right 1,000 times at 5-degree intervals.

However, the motor rotation signal and motor vibration signal of the composite signal illustrated in FIG. 29 are merely examples. The magnitudes of the motor rotation signal and motor vibration signal of the composite signal may be defined in various ways, as long as the drive wheel 20 can rotate while vibrating.

In this way, when the drive wheel 20 rotates while vibrating due to the vibration and rotation of the motor 30, the drive wheel 20 may escape from the rough terrain.

The autonomous mobile robot 1 according to one or more embodiments of the disclosure having the above-described structure may recognize that at least one drive wheel is stuck on the rough terrain using the rough terrain recognition algorithm.

In addition, the autonomous mobile robot 1 according to one or more embodiments of the disclosure having the above-described structure may autonomously escape from the rough terrain using the rough terrain escape algorithm when it is stuck on the rough terrain.

Furthermore, the autonomous mobile robot 1 according to one or more embodiments of the disclosure having the above-described structure may autonomously escape from the rough terrain and then autonomously drive to a destination.

According to an aspect of an example embodiment, an autonomous mobile robot may include a body, drive wheels on the body, motors respectively configured to drive the drive wheels, a suspension on a lower portion of the body and configured to support the motors such that the motors move vertically relative to the body, a sensor on the body and configured to detect surroundings, and a processor configured to control the motors, where the processor is configured to determine that at least one drive wheel of the drive wheels is stuck on a rough terrain based on identifying, using the sensor, that the body is not moving or is moving along a different path from an expected path, and based on determining that the at least one drive wheel is stuck on the rough terrain, vibrate at least one motor of the motors that corresponds to the at least one drive wheel and rotate the at least one motor in a first direction.

The autonomous mobile robot may include a motor driver configured to control the motors, and the processor may be further configured to adjust a gain of the motor driver such that the at least one motor vibrates.

The motor driver may be configured to transmit a composite signal to the at least one motor, the composite signal including a motor rotation signal that causes the at least one motor to rotate and a motor vibration signal that causes the at least one motor to vibrate.

The motors may include a left motor and a right motor, and the suspension may include a left hinge axle and a right hinge axle at the lower portion of the body, a left bogie link rotatably provided on the left hinge axle and including the left motor at a first end thereof, a left front support wheel at a second end of the left bogie link, a right bogie link rotatably provided on the right hinge axle and including the right motor at a first end thereof, and a right front support wheel at a second end of the right bogie link.

The motors may be respectively at a center of the drive wheels.

The drive wheels may include a first drive wheel and a second drive wheel, the motors may include a first motor configured to drive the first drive wheel and a second motor configured to drive the second drive wheel, and the at least one wheel is the first drive wheel and the at least one motor is the first motor.

The processor may be further configured to, based on determining that the first drive wheel is stuck on the rough terrain and that the second drive wheel is not stuck on the rough terrain, vibrate the first motor and rotate the first motor in the first direction and rotate the second motor in the first direction without vibrating the second motor.

The autonomous mobile robot may include a motor driver configured to control the first motor and the second motor, and the processor may be further configured to adjust a gain of the motor driver such that the first motor vibrates and rotates the first motor in the first direction and the second motor rotates in the first direction without vibrating.

The processor may be configured to determine that the at least one drive wheel is stuck on the rough terrain based on a curvature of a current path of the autonomous mobile robot being different from a curvature of the expected path.

The processor may be configured to determine that the at least one drive wheel is stuck on the rough terrain based on a current rotation speed of the at least one drive wheel not matching a target rotation speed of the at least one drive wheel.

According to an aspect of an example embodiment, a method for an autonomous mobile robot, the autonomous mobile robot including a body, drive wheels on the body, motors respectively configured to drive the drive wheels, and a sensor on the body, may include rotating the motors in a first direction at an equal speed, identifying, using the sensor, whether a position of the body changes, determining that the drive wheels are stuck on a rough terrain based on the position of the body not being changed, and based on determining that the drive wheels are stuck on the rough terrain, rotating the drive wheels in the first direction while vibrating the drive wheels vertically relative to the body.

The autonomous mobile robot may include a motor driver configured to control the motors, and the method may include adjusting a gain of the motor driver such that the motors vibrate and rotate in the first direction.

The method may include transmitting, by the motor driver, a composite signal to the motors and the composite signal may include a motor rotation signal that causes the motors to rotate in the first direction and a motor vibration signal that causes the motors to vibrate.

A frequency of the motor rotation signal may be 0.1 Hz, and a frequency of the motor vibration signal may be 50 Hz.

The motor driver may include a proportional-integration-differential controller.

The autonomous mobile robot may include a suspension configured to support the drive wheels.

According to an aspect of an example embodiment, a method for an autonomous mobile robot, the autonomous mobile robot including a body, a first drive wheel and a second drive wheel on the body, a first motor configured to drive the first drive wheel, a second motor configured to drive the second drive wheel, and a sensor on the body, may include rotating the first motor and the second motor in a first direction and at different speeds, identifying, using the sensor, whether a movement path of the body matches an expected path, determining, based on the movement path of the body being different from the expected path, that the first drive wheel is stuck on a rough terrain and based on determining that the first drive wheel is stuck on the rough terrain, and by the first motor, rotating the first drive wheel stuck on the rough terrain in the first direction while vibrating vertically relative to the body.

The autonomous mobile robot may include a motor driver configured to control the first motor and the second motor, the second drive wheel is not stuck on the rough terrain, and the method may include adjusting a gain of the motor driver such that the first motor rotates in the first direction while vibrating, and the second motor to rotate in the first direction without vibrating.

The method may include transmitting, by the motor driver, a composite signal to the first motor, and the composite signal may include a motor rotation signal that causes the first motor to rotate in the first direction and a motor vibration signal that causes the first motor to vibrate.

The motor driver may include a proportional-integration-differential controller.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An autonomous mobile robot comprising:
a body;
drive wheels on the body;
motors respectively configured to drive the drive wheels;
a suspension on a lower portion of the body and configured to support the motors such that the motors move vertically relative to the body;
a sensor on the body and configured to detect surroundings; and
a processor configured to control the motors,
wherein the processor is further configured to:
determine that at least one drive wheel of the drive wheels is stuck on a rough terrain based on identifying, using the sensor, that the body is not moving or is moving along a different path from an expected path, and
based on determining that the at least one drive wheel is stuck on the rough terrain, vibrate at least one motor of the motors that corresponds to the at least one drive wheel and rotate the at least one motor in a first direction.

2. The autonomous mobile robot of claim 1, further comprising:
a motor driver configured to control the motors,
wherein the processor is further configured to adjust a gain of the motor driver such that the at least one motor vibrates.

3. The autonomous mobile robot of claim 2, wherein the motor driver is configured to transmit a composite signal to the at least one motor, the composite signal comprising a motor rotation signal that causes the at least one motor to rotate and a motor vibration signal that causes the at least one motor to vibrate.

4. The autonomous mobile robot of claim 1, wherein the motors comprise a left motor and a right motor, and
wherein the suspension comprises;
a left hinge axle and a right hinge axle at the lower portion of the body,
a left bogie link rotatably provided on the left hinge axle and comprising the left motor at a first end thereof,
a left front support wheel at a second end of the left bogie link,
a right bogie link rotatably provided on the right hinge axle and comprising the right motor at a first end thereof, and
a right front support wheel at a second end of the right bogie link.

5. The autonomous mobile robot of claim 1, wherein the motors are respectively at a center of the drive wheels.

6. A method for an autonomous mobile robot, the autonomous mobile robot comprising a body, drive wheels on the body, motors respectively configured to drive the drive wheels, and a sensor on the body, the method comprising:
rotating the motors in a first direction at an equal speed;
identifying, using the sensor, whether a position of the body changes;
determining that the drive wheels are stuck on a rough terrain based on the position of the body not being changed; and
based on determining that the drive wheels are stuck on the rough terrain, rotating the drive wheels in the first direction while vibrating the drive wheels vertically relative to the body.

7. The method of claim 6, wherein the autonomous mobile robot further comprises a motor driver configured to control the motors, and
wherein the method further comprises adjusting a gain of the motor driver such that the motors vibrate and rotate in the first direction.

8. The method of claim 7, wherein the method further comprises transmitting, by the motor driver, a composite signal to the motors, and
wherein the composite signal comprises a motor rotation signal that causes the motors to rotate in the first direction and a motor vibration signal that causes the motors to vibrate.

9. The method of claim 8, wherein a frequency of the motor rotation signal is 0.1 Hz, and a frequency of the motor vibration signal is 50 Hz.

10. The method of claim 7, wherein the motor driver comprises a proportional-integration-differential controller.

11. The method of claim 6, wherein the autonomous mobile robot further comprises a suspension configured to support the drive wheels.

12. A method for an autonomous mobile robot, the autonomous mobile robot comprising a body, a first drive wheel and a second drive wheel on the body, a first motor configured to drive the first drive wheel, a second motor configured to drive the second drive wheel, and a sensor on the body, the method comprising:
rotating the first motor and the second motor in a first direction and at different speeds;
identifying, using the sensor, whether a movement path of the body matches an expected path;
determining, based on the movement path of the body being different from the expected path, that the first drive wheel is stuck on a rough terrain; and
based on determining that the first drive wheel is stuck on the rough terrain, and by the first motor, rotating the first drive wheel stuck on the rough terrain in the first direction while vibrating vertically relative to the body.

13. The method of claim 12, wherein the autonomous mobile robot further comprises a motor driver configured to control the first motor and the second motor,
wherein the second drive wheel is not stuck on the rough terrain, and
wherein the method further comprises adjusting a gain of the motor driver such that the first motor rotates in the first direction while vibrating, and the second motor to rotate in the first direction without vibrating.

14. The method of claim 13, wherein the method further comprises transmitting, by the motor driver, a composite signal to the first motor, and
wherein the composite signal comprises a motor rotation signal that causes the first motor to rotate in the first direction and a motor vibration signal that causes the first motor to vibrate.

15. The method of claim 13, wherein the motor driver comprises a proportional-integration-differential controller.

16. The autonomous mobile robot of claim 1, wherein the drive wheels comprise a first drive wheel and a second drive wheel,
wherein the motors comprise a first motor configured to drive the first drive wheel and a second motor configured to drive the second drive wheel, and
wherein the at least one drive wheel is the first drive wheel and the at least one motor is the first motor.

17. The autonomous mobile robot of claim 16, wherein the processor is further configured to, based on determining that the first drive wheel is stuck on the rough terrain and that the second drive wheel is not stuck on the rough terrain:
vibrate the first motor and rotate the first motor in the first direction; and
rotate the second motor in the first direction without vibrating the second motor.

18. The autonomous mobile robot of claim 16, wherein the autonomous mobile robot further comprises a motor driver configured to control the first motor and the second motor, and
wherein the processor is further configured to adjust a gain of the motor driver such that the first motor vibrates and rotates the first motor in the first direction and the second motor rotates in the first direction without vibrating.

19. The autonomous mobile robot of claim 1, wherein the processor is configured to determine that the at least one drive wheel is stuck on the rough terrain based on a curvature of a current path of the autonomous mobile robot being different from a curvature of the expected path.

20. The autonomous mobile robot of claim 1, wherein the processor is further configured to determine that the at least one drive wheel is stuck on the rough terrain based on a current rotation speed of the at least one drive wheel not matching a target rotation speed of the at least one drive wheel.
